(19) United States
(12) Patent Application Publication
(10) Pub. No.: US 2017/0291239 A1
(43) Pub. Date: Oct. 12, 2017

(54) METHOD FOR MONITORING THE MACHINE GEOMETRY OF A GEAR CUTTING MACHINE AND AN APPARATUS WITH A GEAR CUTTING MACHINE, A MEASURING DEVICE AND A SOFTWARE MODULE

(71) Applicant: Klingelnberg AG, Zurich (CH)

(72) Inventor: Hartmuth Müller, Remscheid (DE)

(21) Appl. No.: 15/482,247

(22) Filed: Apr. 7, 2017

(30) Foreign Application Priority Data
Apr. 8, 2016 (EP) 16164347.3

(51) Int. Cl. B23F 23/12; G08B 21/18; G06F 17/18; B23Q 17/20

(52) U.S. Cl. CPC B23F 23/1218; B23Q 17/20; G08B 21/187; G06F 17/18

(57) ABSTRACT

A method for monitoring the machine geometry of at least one gear cutting machine (10), having the following steps:
a) measuring a workpiece in a measuring device (20) in order to determine actual data, wherein a workpiece is concerned which was previously machined in the machine (10) on the basis of specification data (VD, ΔVD, MD, ΔMD);
b) correlating the actual data with the specification data (VD, ΔVD, MD, ΔMD) in order to thus determine the deviation of a geometric setting of at least one axis of the machine (10);
c) storing the deviation of the geometric setting;
d) repeating the steps a)-c) after the machining of further workpieces in the machine (10);
e) performing a statistical evaluation of several of the stored deviations in order to determine a geometric change in the axis of the machine (10) by considering a predetermined condition and/or rule.

### CROSS REFERENCE TO RELATED APPLICATIONS

This application claims priority under 35 U.S.C. §§119(a)-(d) to European application no. EP 16164347.3 filed Apr. 8, 2016, which is hereby expressly incorporated by reference as part of the present disclosure.

### FIELD OF INVENTION

The present invention relates to a method for monitoring the machine geometry of a gear cutting machine and an apparatus with a gear cutting machine, a measuring device and a software module which is formed for monitoring the machine geometry.

### BACKGROUND

FIG. 1 shows a schematic view of a gear cutting machine 10 of the prior art (e.g. a gear cutter or a gear-grinding machine) and a measuring device 20 (provided here in form of a separate measuring apparatus) of the prior art (e.g. a coordinate measuring device). The gear-manufacturing machine 10 and the measuring device 20 can be coupled to each other, as indicated by the double arrow 13. The term coupling is used in order to indicate that the machine 10 and the measuring device 20 are at least coupled with respect to communication (i.e. for the exchange of data). This coupling by communication (which is also known as networking) requires that the machine 10 and the measuring device 20 understand the same or a compatible communication protocol and that both follow specific conventions regarding the exchange of data.

The term coupling can also mean that the machine 10 and the measuring device 20 are not only networked but also mechanically connected to each other or integrated completely.

The machine 10 and the measuring device 20 can also form a closed machining and communication circuit (known as closed-loop).

The different axes of the machine 10 and/or the different axes of the measuring device 20 can be controlled for example by a common NC control unit 40. The axes which are controlled by the NC control unit 40 concern numerically controlled axes. Through such a constellation the individual axis movements can be controlled numerically by the NC control unit 40. In at least some embodiments, it is important that the individual movement sequences of the axes of the machine 10 and/or the axes of the measuring device 20 occur in a coordinated manner Said coordination is carried out by the NC control unit 40.

It is also possible to respectively provide both, the machine 10 and also the measuring device 20, with a separate NC control unit. In this case, the networking can be established for the exchange of data between the NC control units for example (e.g. via a network).

The typical procedures ranging from the configuration of a gearwheel up to its production and subsequent measurement are explained by reference to FIG. 2. It concerns a highly schematic diagram in a block representation. There are also other approaches which provide comparable results.

With suitable software SW (e.g. with the configuration software KIMoS™ of the company Klingelnberg GmbH, Germany), a gearwheel or a pair of gearwheels (generally referred to herein as work piece 1) is configured. The software SW can provide data of the workpiece 1 at the end of the configuration process for example These data define the shape of a workpiece 1 to be produced in series for example and the machine kinematics required for this purpose. The machine kinematics can be calculated for example on the basis of a (data) model of the machine 10 to be used.

Since there are also other approaches in order to predetermine the geometry of a workpiece 1 to be produced or machined, the general term of specification data VD is used below for the respective data. The specification data VD are defined in such a way that they at least describe the shape (macro geometry) of a workpiece 1 to be produced. The specification data VD can also additionally describe the micro geometry, which were determined for example on the basis of a mathematical tooth contact analysis. The specification data VD can further also describe the machine kinematics (wherein the kinematic relationships of the gear-manufacturing method and the setting values of the machine 10 are determined for example on the basis of a model of the machine 10 to be used), or the machine kinematics can be provided in form of an additional (separate) data record. The specification data VD can also merely describe the machine kinematics instead of the micro geometry.

These specification data VD can be transferred for example to a process P (e.g. the software COP™ of the company Klingelnberg GmbH, Germany), as shown in FIG. 2. The process P, which can be realised as a software module for example, translates in the illustrated example the specification data VD into machine data MD (which is also partly referred to as machine code or process data), which are converted by the NC control unit of the machine 10 into coordinated movement sequences.

Depending on the embodiment, the specification data VD can also be transferred directly to a suitable machine 10 together with the machine kinematics, as is indicated in FIG. 2 by way of the optional path 14.

The machine 10 now processes the workpiece 1, as predetermined on the basis of the machine data MD. Once this machining (which is also referred to here as gear cutting) has been completed, the workpiece 1 is transferred (directly or indirectly) to the measuring device 20. A predefined measurement sequence is carried out in the measuring device 20 in order to check whether one or several of the current values (which are referred to here as actual data) of the workpiece 1 coincide with the default values of the configuration (in this case the specification data VD). Ideally, the workpiece 1 is absolutely identical to the configuration, i.e. the actual data correspond to the specification data VD. In this case, which is of purely theoretical relevance, the machine data MD can be stored for example in order to produce the gearings of further identical workpieces 1 (e.g. in series).

In practice however, deviations (designated here with ΔVD) between the actual data and the specification data VD are determined during the measurement. These deviations ΔVD can be supplied for example by the measuring device 20 to the process P (in this case the specification data VD would also have to be transferred to the measuring device 20, as indicated in FIG. 2 by the path 15). Depending on the embodiment, the process P for example can now determine corrective values ΔMD for the control of the machine 10 and transfer them to the machine 10. It is also possible however that the process P determines the deviations ΔVD from the measured values which are provided by the measuring device 20.

The machine 10 can either rework the previously toothed and then measured workpiece 1 (by considering the corrective values ΔMD), or the corrective values ΔMD are considered from the machining of the following workpieces 1.

The sequences that are carried out in such a networked machining environment 100 are currently highly precise and robust. Complex gear toothings can currently be produced in a rapid, precise and cost-effective manner.

The aforementioned deviations ΔVD can be used in order to mathematically adjust the geometric settings of the machine 10. This is possible because the geometric settings can be separated from the kinematic values in the described approach. In the case of a machine 10 with three NC-controlled linear axes X, Y, Z and an NC-controlled pivot axis C, the specification data VD for example can thus be converted directly into geometric settings of the axes X, Y, Z and C. If there are now deviations ΔVD, such deviations ΔVD can be converted into modified geometric settings of the axes. These modified geometric settings of the axes are designated herein as follows: X*, Y*, Z* and C.

This practically leads to changes in the reference dimensions, as follows:

ΔX_{ref}=X*−X

ΔY_{ref}=Y*−Y

ΔZ_{ref}=Z*−Z

ΔC_{ref}=C*−C.

The described closed-loop approach, but also other similarly networked solutions, thus allows a progressive optimization of the reference dimensions of a machine 10.

### SUMMARY OF THE INVENTION

It is the object of at least some embodiments to provide a technical approach for the reliable and timely determination of changes in a machine or a machining environment.

In at least some embodiments, one or more of the above objects is achieved by a method according to at least some embodiments disclosed herein and/or by an apparatus (referred to as machining environment) according to at least some embodiments disclosed herein.

At least some embodiments of the invention are based on providing a statistical long-term evaluation and a statistical short-term evaluation as well as placing these two evaluations in correlation. Rules and/or conditions. e.g., predetermined or predefined rules, may be applied in carrying out the correlation in order to determine whether or not there is a distinct deviation/change per definition, e.g., a deviation is predefined as a “distinct” deviation.

In at least some embodiments, the provision of the statistical long-term evaluation and the statistical short-term evaluation as well as the correlation of these two evaluations is carried out by an analytic module.

The term analytic module is used here in order to describe a functional group which is realised in hardware, software or as a combination of hardware and software. An analytic module in form of a software module is used in at least some embodiments, e.g., a computer program product and/or a non-transitory machine-readable storage medium with instructions stored thereon, which module is configured to be installed on a suitable computer in order to carry out the steps of the method in accordance with at least some embodiments of the invention and/or to control their operation. Said computer, and the analytic module respectively, can also be part of a machine and/or a measuring device in at least some embodiments.

In at least some embodiments, the statistical short-term evaluation concerns a sliding statistical evaluation, which respectively only considers a predetermined number of newer measurements or the newest measurements within a predetermined time frame.

In at least some embodiments, the machine and the measuring device of the invention are or can be networked with the analytic module.

The machine and the measuring device of at least some embodiments of the invention can not only be networked, but can also be connected to each other mechanically or completely integrated.

The machine and the measuring device of at least some embodiments of the invention can also form a closed machining and communication circuit (known as closed-loop), wherein the analytic module can be connected for communication purposes to the machining and communication circuit.

At least some embodiments of the invention are also concerned with optimising the sequence from the design of a gear toothing to its production and inspection and to allow recognizing faults at an early time and in a secure manner

At least some embodiments of the invention can especially be used in networked production processes (also known as networked machining environment) in order to allow a response to changes at any time in an appropriate and timely manner

The data which are used in this case can be exchanged in at least some embodiments directly between the involved components (e.g. a gear cutting machine and a measuring device), or they can be provided for example in a development database or in a production database in a network and can be retrieved from there when necessary.

### BRIEF DESCRIPTION OF DRAWINGS

The drawings are described in context and comprehensively. The embodiments of the invention are described below in closer detail by reference to the drawings.

FIG. 1 shows a schematic view of a gear cutting machine and a measuring device of the prior art, which are connected to each other by communication;

FIG. 2 shows a schematic block representation of a machining environment of the prior art, which in the illustrated embodiment comprises a gear cutting machine, a measuring device, software and a process;

FIG. 3 shows a schematic diagram in which the frequency of changes in the reference dimensions and the respective curve of a normal distribution of a machine is entered;

FIG. 4 shows a schematic diagram in which the details of the diagram of FIG. 3 are entered on the one hand and the details of a sudden change on the other hand;

FIG. 5A shows a schematic block representation of an exemplary networked machining environment of the invention, which in the illustrated example comprises a gear cutting machine, a measuring device, software (e.g., a computer program product and/or a non-transitory machine-readable storage medium with instructions stored thereon), a process and an analytic model (here in a portable computer);

FIG. 5B shows a schematic block illustration of an exemplary implementation of the analytic module on a first (stationary) computer and a second (portable) computer;

FIG. 6A shows a schematic diagram in which the frequency of changes in the reference dimensions and the respective curve of a normal distribution of the X-axis of a machine are entered on the one hand and the details of a sudden change on the other hand;

FIG. 6B shows a schematic diagram in which the frequency of changes in the reference dimensions and the respective curve of a normal distribution of the Y-axis of the machine are entered on the one hand and the details of a sudden change on the other hand;

FIG. 6C shows a schematic diagram in which the frequency of changes in the reference dimensions and the respective curve of a normal distribution of the Z-axis of the machine are entered on the one hand and the details of a sudden change on the other hand;

FIG. 6D shows a schematic diagram in which the frequency of changes in the reference dimensions and the respective curve of a normal distribution of the C-axis of the machine are entered on the one hand and the details of a sudden change on the other hand;

FIG. 7A shows a schematic time diagram which was derived for example from FIG. 6A;

FIG. 7B shows a schematic time diagram which was derived for example from FIG. 6B;

FIG. 7C shows a schematic time diagram which was derived for example from FIG. 6C;

FIG. 7D shows a schematic time diagram which was derived for example from FIG. 6D;

FIG. 8 shows a schematic block illustration of a portable computer which indicates the time diagrams of FIGS. 7A to 7D and displays a message;

FIG. 9 shows a schematic flowchart of a further embodiment of the invention.

### DETAILED DESCRIPTION OF EMBODIMENTS

Terms are used in connection with the present description which are also used in relevant publications and patents. Notice shall be taken however that the use of these terms is only provided for the purpose of better understanding. The inventive concept and the scope of protection of the claims shall not be limited in their interpretation by the specific choice of the terms. At least some embodiments of the invention can easily be transferred to other systems of concepts and/or specialist areas. The terms shall be applied analogously in other specialist areas.

The changes in the aforementioned reference dimensions (i.e. the geometric change in the settings of the machine 10) can be considered over time t and evaluated by using statistical methods for example. This will be explained below by reference to a simple example

If one assumes for example that the deviation ΔVD indicates only one single deviation, which indicates a displacement of the X-axis of the machine 10 for example (e.g. an expansion as a result of temperature influences), the following would apply in this special case to the changes in the reference dimensions:

ΔX_{ref}=X*−X≠0

ΔY_{ref}=0

ΔZ_{ref}=0

ΔC_{ref}=0.

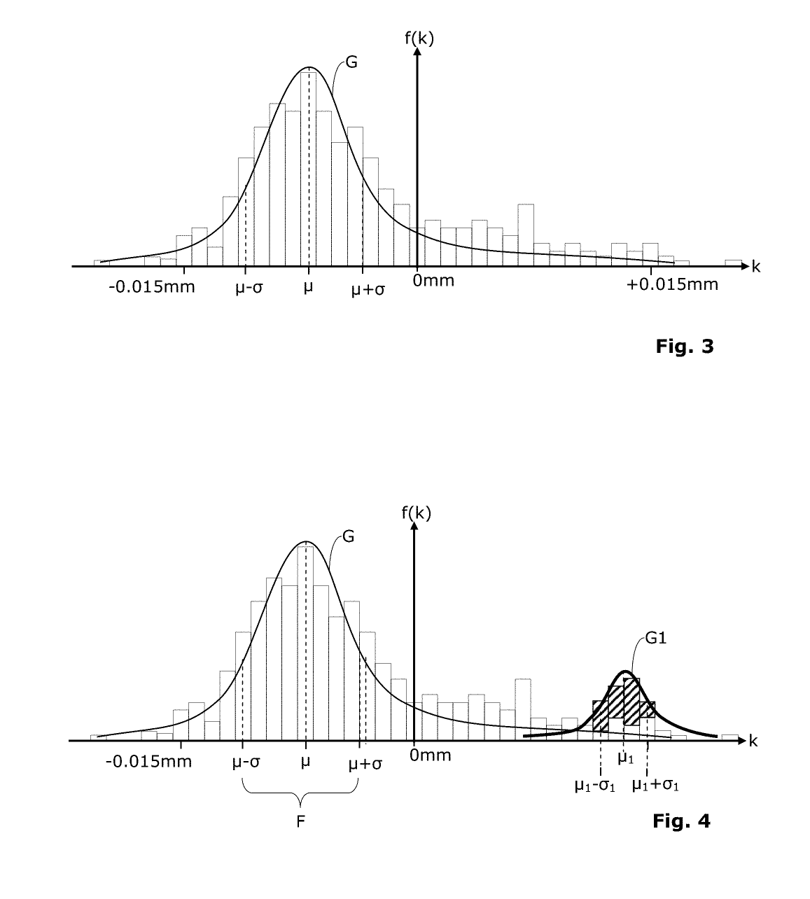

In the diagram of FIG. 3, the statistical evaluation of the respective machine 10 with changes in the reference dimensions of the X-axis over a longer period of time is shown by way of example and in a schematic illustration. The changes k in the reference dimensions of the X-axis are entered in millimetres on the horizontal axis of the diagram and the statistical frequency f(k) is shown on the vertical axis. A type of normal distribution is obtained in this example, which is shown as the curve G. The curve G has a maximum approximately at μ=−0.007 mm, i.e. on average over m (m is a natural number greater than zero) production processes the X-axis of the machine 10 is shorter by 0.007 mm than it actually should be. FIG. 3 also shows the variance σ. The formula, which was used by way of example for statistical calculation, is the following:

$$f ( k ) = \frac{1}{σ \sqrt{2 π}} {e}^{- \frac{1}{2} {( \frac{k - μ}{σ} )}^{2}}$$

The invention is primarily concerned with the determination of deviations from the norm. The diagram of FIG. 4 again shows the statistical evaluation of the machine 10 with changes in the reference dimensions of the X-axis over a longer period of time of m production processes. The curve G of FIG. 4 corresponds to the curve G of FIG. 3.

Discrete values for the deviations are respectively entered in FIGS. 3, 4 and FIGS. 6A to 6D. The height of the illustrated columns corresponds to the number of the production processes for example, in which a specific deviation (e.g. in millimetres) occurred. The fact that the illustrated columns have a constant width (also known as quantization) shows that the geometric deviations (e.g. in millimetres) are determined in discrete steps.

Instead of such an illustration with columns, other statistical evaluation and/or representation methods can also be used in at least some embodiments.

The statistical evaluation of the last n production processes (referred to herein as short-term evaluation) now suddenly shows a distinct change in the reference dimensions (n is a natural number greater than zero, wherein it applies: n is less than m). The respective values are illustrated in FIG. 4 by hatched boxes and a different normal distribution, which is shown as the curve G1, is shown for these n production processes. The curve G1 has a maximum approximately at μ₁=+0.014 mm, i e on average over n production processes the X-axis of the machine 10 is longer by 0.014 mm than it actually should be (always relating to the zero point at 0 mm). The variance σ₁ in relation to curve G1 is also shown in FIG. 4.

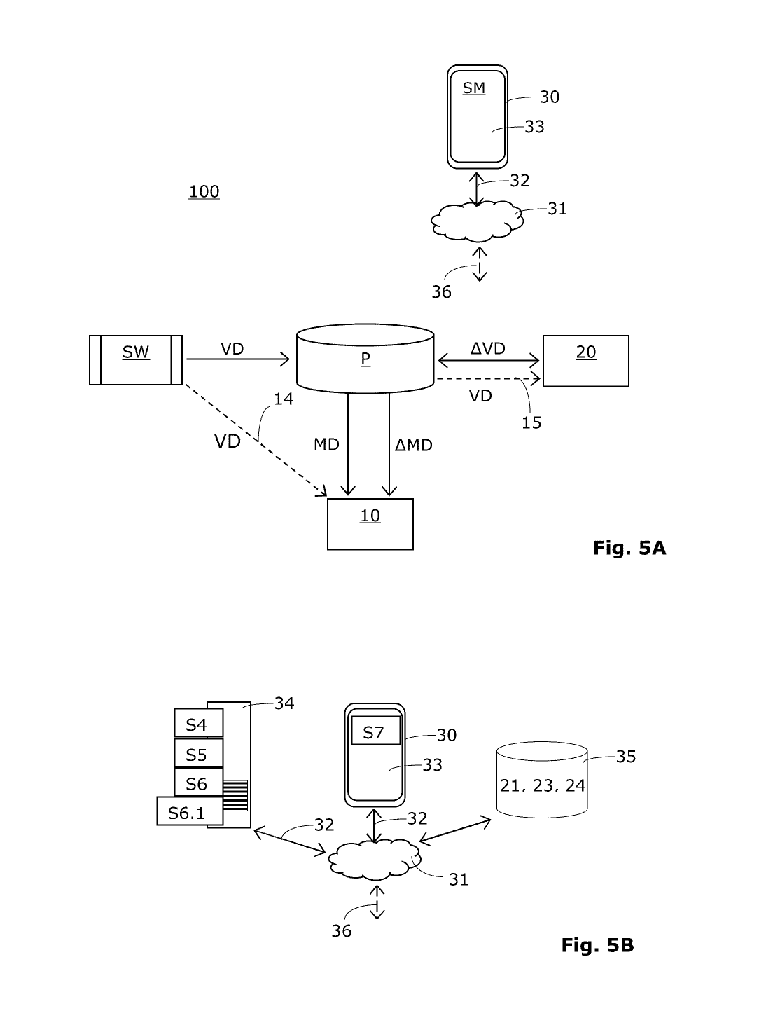

If a comparison of the statistical long-term value μ with the statistical short-term value μ1 is carried out by using an analytic module SM in accordance with at least some embodiments of the invention (e.g. as a software application on a portable computer 30, as shown in FIG. 5A, or as a software application on a portable computer 30 and a stationary computer 34, as shown in FIG. 5B), deviations as shown in FIG. 4 by way of example can be recognized automatically. The comparison of the statistical mean values μ and μ1 as described here shall be understood as an example for a statistical evaluation. Other statistical evaluations by means of the analytic module SM can also be carried out in at least some embodiments.

A respective embodiment of the invention is shown in FIG. 5A. FIG. 5A is based on FIG. 2. Reference is therefore also made to the description of FIG. 2.

FIG. 5A shows a networked machining environment 100 with a portable computer 30 (e.g. a mobile phone or a PDA). The computer 30 can be networked with the machining environment 100. Said networking is illustrated in FIG. 5A by a cloud 31.

An analytic module SM is used in at least some embodiments of the invention, which module is designed to process statistical values of at least one machine 10 in order to automatically recognize deviations (as shown by way of example in FIG. 4).

The analytic module SM can be realised in at least some embodiments as a software module or it can be integrated in a different software (e.g. in the software SW and/or in the process P), or the analytic module SM can be provided as a module of a software suite.

An analytic module SM is used in at least some embodiments which comprises at least one (hardware and/or software) interface 32, which is designed for accepting data from a machine 10 and/or a measuring device 20 and/or a different software SW and/or a process P.

Either the machine 10, the measuring device 20, the other software SW or the process P can comprise a (hardware and/or softer) interface which respectively transfers data to the analytic model SM (known as push approach), or the analytic module SM is designed to collect data from a machine 10, or from a measuring device 20, or from the other software SW or from the process P (known as pull approach). A combination of the push and pull approach can also be used in at least some embodiments.

In at least some embodiments, the networked machining environment 100 is formed to carry out the following method for monitoring the machine geometry of at least one gear cutting machine 10. The following steps are carried out:
a) Machining the toothing of a workpiece 1 on the machine 10 on the basis of specification data (e.g. VD, ΔVD, MD, ΔMD),
b) measuring the workpiece 1 in a measuring device 20 (which is part of the machine 10, or which can be connected to the machine 10) in order to determine the actual data,
c) correlating the actual data with the specification data (e.g. VD, ΔVD, MD, ΔMD) in order to thus determine the deviation of a geometric setting of at least one axis X of the machine 10,
d) storage of the deviation of the geometric setting
e) repetition of the steps a) to d) during the machining of the gear toothing of m further workpieces 1,
f) performance of a statistical evaluation of several of the stored deviations (e.g. all m deviations) in order to determine from these deviations a statistical reference dimension (e.g. in form of the statistical long-term mean value u) for the axis X of the machine 10.

The software SW and the process P can interact as mentioned above within the scope of step a) for example for the first-time and/or single machining of a workpiece 1 in order to provide the machine 10 with machine data MD as specification data.

As already explained above, a workpiece 1 that was machined for the first time can be measured in a measuring device 20 in order to rework the workpiece 1 that was processed for the first time or in order to obtain corrected data for the subsequent series production of further identical workpieces 1.

Within the scope of series production of workpieces 1, corrected data for example (e.g. as machine data MD together with the deviations ΔMD or as specification data VD together with the deviations ΔVD) can be loaded from a memory in step a).

Within the scope of series production of workpieces 1, the first workpiece 1 and every 100^{th} workpiece 1 for example can be measured in the measuring device 20 in order to respectively determine reference dimensions and/or changes in the reference dimensions from time to time.

Depending on the embodiment, any of the m workpieces of a series production however can be measured in the measuring device 20 within the machining environment 100. Reference dimensions and/or changes in reference dimensions are obtained for each of the m workpieces. The result of such a measurement series with m workpieces 1 is shown by way of example in FIG. 4 (see curve G).

This means that depending on the embodiment, changes in the reference dimensions of at least one machine axis (e.g. the X-axis) of the machine 10 can be determined in regular or irregular intervals, e.g., time intervals.

In at least some embodiments, a sliding statistical evaluation of the respectively latest measurement results (e.g. the last n measurement results with n<m) is carried out by the networked machining environment 100. The sliding statistical evaluation can be carried out in at least some embodiments by an element of the machining environment 100 (e.g. by the analytic module SM) and/or by several elements of the machining environment 100 (e.g. by the process P together with the aforementioned analytic module SM).

In at least some embodiments the analytic module SM can also comprise a master module for example, which runs in the control unit 40 of the machine 10 or in a stationary computer 34 (see FIG. 5B), and a client module, wherein the client module is executed in a portable computer 30 for example.

This sliding statistical evaluation is primarily used to recognize “distinct” changes in the reference dimension in comparison with older reference dimensions in respect of time. If such a statistical evaluation were carried out in a cumulative manner over all m previous changes in the reference dimension, sudden deviations would hardly be recognizable.

This is primarily about the recognition of a culmination of “distinct” changes in the reference dimensions. Such a culmination is shown in FIG. 4 by the curve G1. In the illustrated embodiment, a secondary maximum (averaged over n workpieces 1) has been obtained at a mean value μ₁. Said secondary maximum deviates distinctly from the main maximum μ (averaged over m workpieces 1).

A deviation is designated in at least some embodiments of the invention as a “distinct” change in the reference dimension which is at least 20% of the mean value μ. This means that a distinct deviation is present per definition when μ₁ is greater or lower than μ by 20%. The criterion which is used for recognizing a “distinct” change concerns a relative criterion. The relative threshold value was determined in this case at 20%.

In at least some embodiments, a “distinct” change in the reference dimension is a deviation whose mean value μ₁ lies outside of the range or window F (see FIG. 4), which is defined by the variance u of the long-term average μ as follows:

μ·σ<F<μ+σ

This means a distinct deviation is present in these embodiments per definition if μ₁ is less than μ−σ, or if μ₁ is greater than μ+σ. This also concerns a relative criterion because the criterion which is used in this case for recognizing a “distinct” change is defined relative to the window F. The window F was determined in this case as the relative threshold value.

A deviation can also be designated in at least some embodiments as a “distinct” change in the reference dimension which has a different or opposite sign than the mean value μ (one is positive and one is negative, or vice versa). This means a distinct deviation is present in these embodiments per definition if the mean value u is less than zero for example and if μ₁ is greater than zero (as shown in FIG. 4), or vice versa. A change in the sign was determined here as the threshold value.

A deviation can also be designated in at least some embodiments as a “distinct” change in the reference dimension which is obtained in that the variance of the long-term average μ shows a trend or tendency. A trend or tendency can be recognized for example in such a way that the window F, as defined above, becomes greater or smaller.

A “distinct” change in the reference dimension can also be assumed as given in at least some embodiments if within the scope of the statistical short-term evaluation it is impossible to determine a normal distribution of a number of n=10 production processes for example. The fact that the last change in the reference dimension cannot be described by a normal distribution indicates the presence of a special case which should be brought to the attention of the user by triggering or initiating a reaction, e.g. an automated preselected or predetermined action of the apparatus, for example.

Depending on the embodiment, the analytic module SM can also be formed in such a way that the user can define a change in the reference dimension as a distinct change by predetermining a relative and/or absolute threshold value for example.

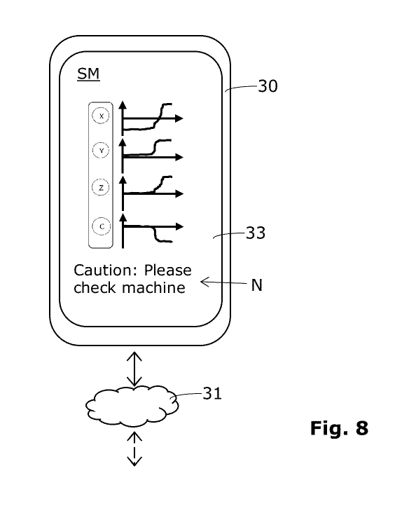

The machining environment 100 is formed in at least some embodiments in such a way that an action, e.g., a preselected or predetermined action is triggered or initiated in the presence of a “distinct” change. The analytic module SM is formed in at least some embodiments for the purpose of triggering or initiating an action or carrying out the action itself (e.g. by indicating a message N on a display, as shown in FIG. 8).

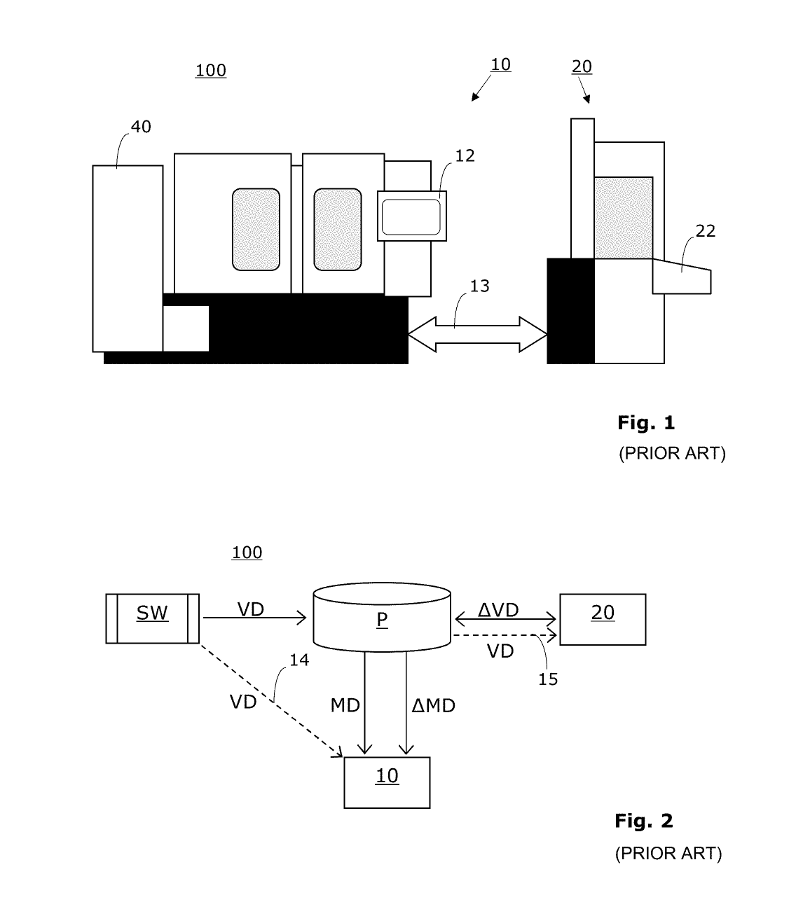

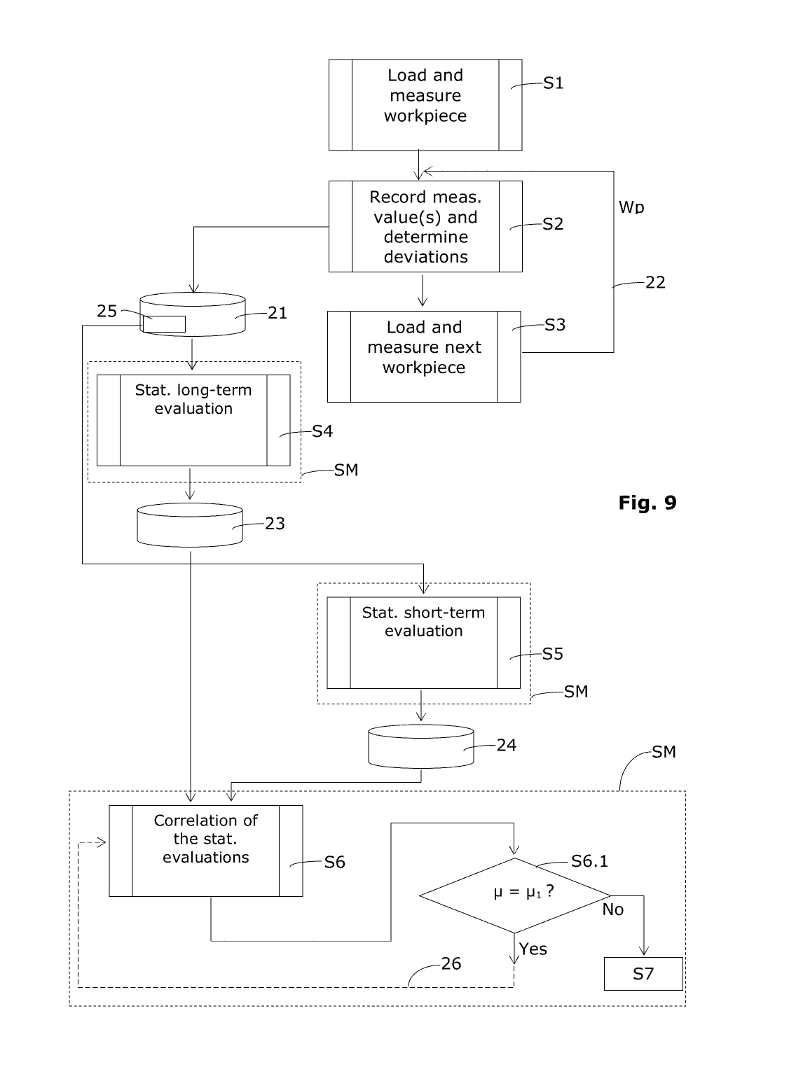

The triggering of an action (step S7 in FIG. 9) can comprise in at least some embodiments one or several of the following steps for example:
output of an acoustic warning;
output of a visual warning, which in at least some embodiments comprises a notification on a display 12 (FIG. 1) or 33 (FIG. 5A);
posting of a message N (e.g. per SMS);
dispatch of an email message.

In the machining environment 100, which shall be understood by way of example, a “distinct” change in the reference dimensions can be caused for example by improper handling of the machine 10, wherein the X-axis was damaged by collision for example

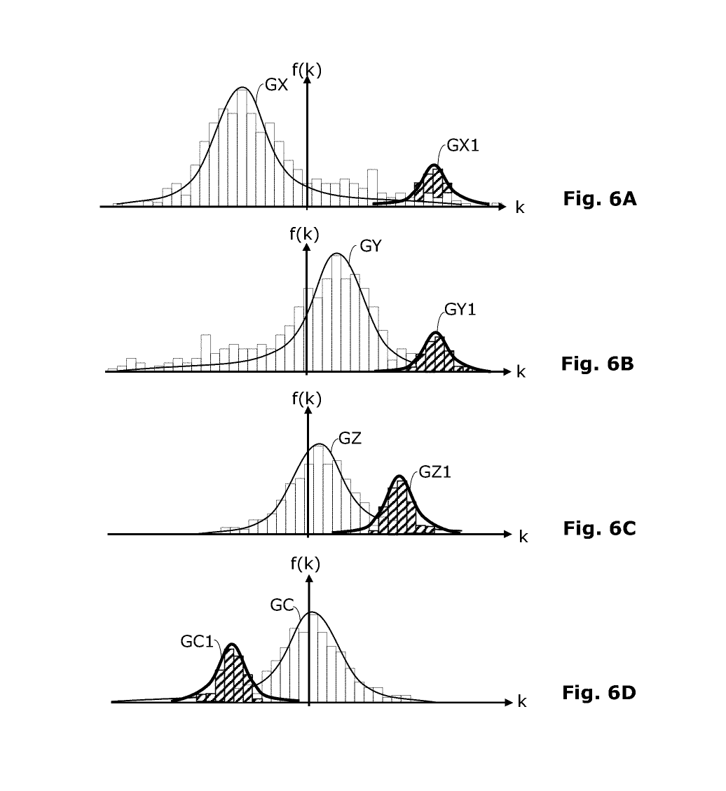

A further embodiment of the invention is described by reference to FIGS. 6A to 6D. A machining environment 100 is concerned again, which comprises a gear cutting machine 10 and a measuring device 20. The machine 10 again comprises three NC-controlled linear axes X, Y, Z and an NC-controlled pivot axis C. In this case, not only the changes in the reference dimension of the X-axis are statistically evaluated, but also the changes in the reference dimensions of all three further axes Y, Z and C. Each of the FIGS. 6A to 6D shows a respective statistical long-term evaluation (e.g. over m machining cycles) and a sliding statistical short-term evaluation (e.g. over n machining cycles). The result of the statistical long-term evaluation of the X-axis (see FIG. 6A) can be represented by a normal curve GX and the result of the statistical short-term evaluation by a normal curve GX1. The result of the statistical long-term evaluation of the Y-axis (see FIG. 6B) is represented by a normal curve GY and the result of the statistical short-term evaluation by a normal curve GY1. The result of the statistical long-term evaluation of the Z-axis (see FIG. 6C) is represented by a normal curve GZ and the result of the statistical short-term evaluation by a normal curve GZ1. The result of the statistical long-term evaluation of the C-axis (see FIG. 6D) is represented by a normal curve GC and the result of the statistical short-term evaluation by a normal curve GC1.

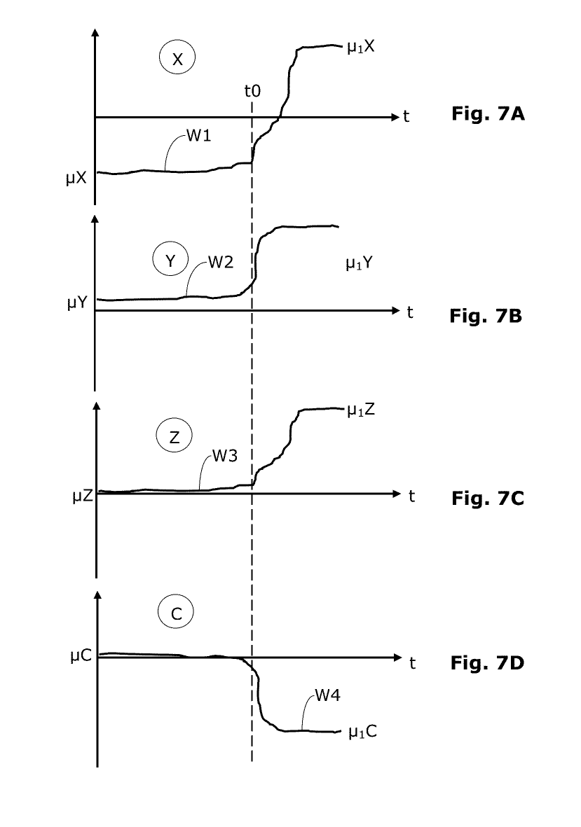

It can be recognized on the basis of FIGS. 6A to 6D that a distinct change has occurred in all four axes. The occurrence of these changes can also be represented by time diagrams, as shown schematically and by way of example in FIGS. 7A to 7D.

The time diagrams of FIGS. 7A to 7D can be derived from FIGS. 6A to 6D, and/or from the data which are based on the statistical evaluations of FIGS. 6A to 6D.

Each of the four axes X, Y, Z and C can be associated with a curve W1-W4 in the time diagram for example, which respectively show the progression of the average value μ over the time t. FIG. 7A shows the respective time progression of the mean value μX of the X-axis over time t. The mean value μX was approx.=−0.007 mm over a longer period of time. From a specific point in time, which is designated here with t0, the mean value has changed to a valueμ₁X, which at approximately 0.014 mm now lies distinctly in the positive range. FIG. 7B shows the respective time progression of the mean value μY of the Y-axis over time t. The mean value μY was approx.=+0.003 mm over a longer period of time. Approximately at the point in time t0 the mean value changed to a value μ₁Y at approximately 0.015 mm FIG. 7C shows the respective time progression of the mean value μZ of the Z-axis over time t. The mean value μZ was approximately=+0.001 mm over a longer period of time. Approximately at the point in time t0 the mean value changed to a value μ₁Z at approximately+0.01 mm. FIG. 7D shows the respective time progression of the mean value μC of the C-axis over time t. The mean value μC was slightly above zero in the positive range over a longer period of time. Approximately at the point in time t0 the mean value changed to a value μ₁C at approximately −0.008 mm. The illustrations of FIGS. 6A to 7D are not true to scale and the numbers stated here shall be understood as examples.

As a result of the fact that statistical long-term evaluations and statistical short-term evaluations are concerned, individual outliers of the measurements are relatively insignificant. The statistical evaluation leads to a kind of filtering in which only values (changes) have an effect which occur several times.

The respective (mathematical) filter, which can be used in the statistical short-term evaluation, can either work with a fixed threshold or it can work with a threshold which is predeterminable (e.g. by a user). The number q can be used as a type of threshold for example (wherein q>>0 and q<<m). The sensitivity of the statistical short-term evaluation can be predetermined by the threshold q. If q were equal 1, every one-off measurement outlier would already lead to the triggering of an action. The following should apply so that the sensitivity is not too high: q>>0.

The threshold q, if present, can be predetermined in at least some embodiments as an absolute (e.g. q=10) or as a relative threshold value (e.g. q=m/10).

In at least some embodiments, a compromise is sought here between an excessively sensitive evaluation which already triggers an action upon first-time occurrence (e.g. q=1) of a deviation and an evaluation which only indicates the cumulative occurrence of deviations at a time which is too late and with a time delay.

The number of the measurements m can be updated in at least some embodiments over an open period of time (e.g. several days or weeks) and can be evaluated within the scope of the statistical long-term evaluations.

The number of the measurements m can also be updated in at least some embodiments over a limited or predefined period of time (e.g. by an absolute number m=100 or by a time window, e.g. from the point in time from which the machine 10 has warmed up until the cut-off of the machine in the evening) and can be evaluated within the scope of statistical long-term evaluations.

A further optional feature of at least some embodiments of the invention is now described by reference to FIGS. 7A to 7D. As already described, various threshold values and/or filter parameters can or will be predetermined in order to influence the behaviour of the mathematical evaluation and triggering of a reaction.

In the case of embodiments in which the deviations are evaluated by more than one axis, a set of rules can be used which allows correlating the progression of the curves W1, W2, W3 and W4 to each other (with respect to time).

A set of rules can also be used in order to evaluate the curves of FIGS. 6A to 6D and to correlate them to each other.

The criterion which defines the occurrence of a distinct change can be determined as follows for example (the following examples can be used in at least some embodiments):
If at least two of the curves W1, W2, W3 and W4 show a sudden change within a predefined time window (of 10 minutes for example) and/or workpieces/production processes (n-4, for example), then this can be interpreted as a distinct change; and/or
if at least two of the curves W1, W2, W3 and W4 show a sudden change whose height of the sudden change deviates in the time diagram by at least 20% from the mean value of the statistical long-term evaluation, then this can be interpreted as a distinct change; and/or
if at least two of the curves W1, W2, W3 and W4 show a zero crossing or passage (e.g., the sign of the value changes, i.e., from positive to negative or negative to positive, or the value crosses an axis or zero value), such as the curves W1 and W4 for example), then this can be interpreted as a distinct change.

These criteria shall be understood as examples and they can be modified, supplemented by further criteria and combined.

It is also possible to predetermine more complex sets of rules in at least some embodiments.

It is also possible to combine definitions which were described in connection with FIGS. 6A to 6D with the definitions which were described in connection with FIGS. 7A to 7D.

At least one of the actions, which are mentioned by way of example (step S7), is triggered in at least some embodiments upon reaching the point in time t0.

In order to inform the user at any time about the presence of special deviations, the analytic model SM can indicate an illustration on a display 33 for example, as shown in FIG. 8. In the illustration, which is shown for example on the display 33 of a PDA used as a computer 30, a copy of the curves W1-W4 as shown in FIGS. 7A to 7D can be concerned, or an amended or adjusted version of these curves W1-W4 can be shown. The display 33 of the PDA used as the computer 30 shows the following message N as a potential action (step S7): “Caution: Please check machine”.

A further embodiment of the invention is described by reference to a schematic flowchart which is shown in FIG. 9.

In a first step 51, a first work piece 1 is loaded into a measuring device 20 and then measured. Current measurement value(s) are recorded in step S2 and deviations ΔVD and/or ΔMD are determined. These deviations can be determined for example by the measuring device 20 and/or the process P and/or the analytic module SM. At least one value (e.g. the deviation ΔVD for the X-axis of the machine 10) can be stored in a memory 21. A subsequent work piece 1 is now loaded into the measuring device 20 and measured (step S3). This process is repeated several times, as illustrated in FIG. 9 by the loop 22. The number of repetitions Wp or passages of the loop 22 can be equated in this case with the number of production processes m for example. In this case (i.e. if Wp=m) each of the m workpieces 1 processed by the machine 10 is measured with the measuring device 20. If for example only every other workpiece 1 is measured, then Wp=m/2 applies.

In at least some embodiments the analytic module SM can retrieve stored values from the memory 21 in a continuous manner or from time to time and subject them to a first statistical evaluation (step S4). As already described by reference to an example, the mean value μ for example can be calculated within the scope of this first statistical evaluation and be stored in a memory 23. The memory 21 can be identical with the memory 23. This also applies to all further memories which are mentioned here.

At the same time or from time to time, the analytic module SM can retrieve stored values from the memory 21 and subject them to a second statistical evaluation (step S5). Depending on the embodiment, the analytic module SM can only retrieve and process stored values of the last hour for example or only the last n stored values for example. The second statistical evaluation concerns the aforementioned statistical short-term evaluation, which is also referred to here as sliding evaluation. The fact that within the scope of the statistical short-term evaluation only a subset of the respectively latest values are retrieved from the memory 21 and are statistically evaluated is indicated in FIG. 9 by a small window 25 on the memory 21. As already described by reference to an example, the mean value μ₁ can be calculated for example within the scope of said second statistical evaluation and can be stored in a memory 24.

The steps S4 and S5 can also be carried out simultaneously in at least some embodiments.

The calculation of the mean values μ and μ₁ shall only be understood as a possible example for the statistical evaluation. Other statistical evaluations can also be carried out in this case by the analytic module SM.

The results of the statistical short-term evaluation and the statistical long-term evaluation are correlated in a further step S6 in order to allow the recognition of “distinct” deviations. As is shown in FIG. 9 by way of example, the respective results from the memories 23 and 24 are compared for this purpose by the analytic module SM.

Depending on the definition and/or set of rules used for determining a “distinct” deviation (a number of examples have already been mentioned), the correlation is provided in different ways.

In the simplest of all cases, it is checked within the scope of step S6 whether μ=μ₁ applies. If μ should be equal to μ₁ then there is no change which could be regarded as a distinct change. If in this case u is not equal to μ₁ then there is a distinct change per definition and an action (step S7) would be triggered. This simple example is shown in FIG. 9, wherein the comparison process which is regarded as a part of step S6 is designated here as a partial step S6.1. If μ should be equal to μ₁, i.e. if there is no change, the method of this embodiment can lead back to step S6, as indicated in FIG. 9 by the loop 26.

In the embodiment of FIG. 9, the steps S4, S5, S6, S6.1 and S7 are carried out by the analytic module SM or controlled by said module.

It is irrelevant for at least some embodiments of the present invention however where these individual steps are carried out. The step S4 and/or the step S5 can be carried out in the machine 10 for example, whereas the remaining steps are carried out in a (stationary) computer for example (e.g. a computer 34) which is networked with the machining environment 100.

FIG. 5B schematically shows a further embodiment. The steps S4, S5, S6 and S6.1 can be carried out in a (stationery) computer 34 for example and the step S7 can be outsourced in an application in such a networked implementation of the machining environment for example, which application only displays a message N and/or the diagrams (as shown in FIG. 8) on a portable computer 30 on a display 33. The computers 30 and 34 as well as an optional network memory 35 can communicate with each other via a network 31. The network 31 can be incorporated in the communication infrastructure of the machining environment 100, as indicated in FIGS. 5A and 5B by the arrow 36.

It should be understood that the features disclosed herein can be used in any combination or configuration, and is not limited to the particular combinations or configurations expressly specified or illustrated herein. Thus, in some embodiments, one or more of the features disclosed herein may be used without one or more other feature disclosed herein. In some embodiments, each of the features disclosed herein may be used without any one or more of the other features disclosed herein. In some embodiments, one or more of the features disclosed herein may be used in combination with one or more other features that is/are disclosed (herein) independently of said one or more of the features. In some embodiments, each of the features disclosed (herein) may be used in combination with any one or more other feature that is disclosed herein.

Unless stated otherwise, terms such as, for example, “comprises,” “has,” “includes,” and all forms thereof, are considered open-ended, so as not to preclude additional elements and/or features.

Also unless stated otherwise, terms such as, for example, “a,” “one,” “first,” are considered open-ended, and do not mean “only a,” “only one” and “only a first,” respectively. Also unless stated otherwise, the term “first” does not, by itself, require that there also be a “second.”

Also, unless stated otherwise, terms such as, for example, “in response to” and “based on” mean “in response at least to” and “based at least on”, respectively, so as not to preclude being responsive to and/or based on, more than one thing.

Also, unless stated otherwise, the phrase “A and/or B” means the following combinations: (i) A but not B, (ii) B but not A, (iii) A and B. It should be recognized that the meaning of any phrase that includes the term “and/or” can be determined based on the above. For example, the phrase “A, B and/or C” means the following combinations: (i) A but not B and not C, (ii) B but not A and not C, (iii) C but not A and not B, (iv) A and B but not C, (v) A and C but not B, (vi) B and C but not A, (vii) A and B and C. Further combinations using and/or shall be similarly construed.

As may be recognized by those of ordinary skill in the pertinent art based on the teachings herein, numerous changes and modifications may be made to the above-described and other embodiments without departing from the spirit and/or scope of the invention. Accordingly, this detailed description of embodiments is to be taken in an illustrative as opposed to a limiting sense.

1-12. (canceled)

13. A method for monitoring a machine geometry of at least one gear cutting machine, the method comprising the following steps:
a) measuring a workpiece in a measuring device and determining measurement data therefrom, wherein the workpiece was previously machined in the machine on a basis of specification data;
b) correlating the measurement data with the specification data and determining a deviation of a geometric setting of at least one axis of the machine;
c) storing the deviation of the geometric setting;
d) repeating steps a)-c) after machining further workpieces in the machine;
e) performing a statistical evaluation of multiple of the stored deviations and determining a change in at least one reference dimension of the at least one axis of the machine based at least in part on at least one predefined condition and/or rule.

14. A method according to claim 13, including performing said determining a change in at least one reference dimension of the at least one axis at regular or irregular intervals.

15. A method according to claim 13, further comprising initiating a preselected or predetermined action upon occurrence of a deviation in the at least one reference dimension that is predefined as distinct deviation therein.

16. A method according to claim 13, wherein the statistical evaluation includes a statistical long-term evaluation of a number of m workpieces and a statistical short-term evaluation of a number of n workpieces, wherein n<m.

17. A method according to claim 16, wherein said at least one predefined condition and/or rule defines the presence of a distinct deviation, and the method further comprises correlating the statistical long-term evaluation with the statistical short-term evaluation and determining whether at least one of said at least one predefined condition and/or rule has been met.

18. A method according to claim 13, wherein said at least one predefined condition and/or rule includes at least one of the following conditions:
whether both a statistical main maximum and a statistical secondary maximum exist and whether the statistical main maximum is not equal to the statistical secondary maximum;
whether both a statistical main maximum and a statistical secondary maximum exist and whether there is a deviation of at least 20% between the statistical main maximum and the statistical secondary maximum;
whether a variance a to a statistical long-term normal distribution exists and whether a statistical secondary maximum exists that lies outside of a range defined as μ−σ<F<μ+σ;
whether both a statistical long-term normal distribution with a first main maximum and a statistical short-term normal distribution with a second main maximum exist, wherein the first main maximum has a different sign than the second main maximum;
whether a variance a to a statistical long-term normal distribution exhibits a trend;
whether a statistical short-term evaluation which does not exhibit a normal distribution exists;
whether a statistical short-term evaluation which exceeds an absolute or relative threshold value exists.

19. A method according to claim 13, wherein said at least one predefined condition and/or rule includes at least one of the following rules:
whether at least two time diagrams which show a change within a predefined period of time exist;
whether at least two time diagrams which show a change within a predefined period of time or within predefined number of workpieces exist, whose height of change in at least one of said at least two time diagrams deviates at least 20% from a mean value of a statistical long-term evaluation;
whether at least two time diagrams which show a zero crossing exist.

20. A method according to claim 17, further comprising initiating a preselected or predetermined action when at least one of said at least one condition and/or rule that defines the presence of a distinct deviation is met.

21. A method according to claim 15, wherein the action includes one or more of the following:
emitting an acoustic warning;
emitting a visual warning;
posting of a message;
dispatching an email message.

22. A method according to claim 21, wherein the visual warning includes a notification on a display.

23. An apparatus comprising:
at least one gear cutting machine; and
a measuring device,
wherein said apparatus further comprises, or is operatively connectable to, an analytic module to perform or initiate:
a statistical long-term evaluation of geometric data of the machine determined on a basis of m measurements performed by the measuring device on workpieces previously processed by the machine;
a statistical short-term evaluation of geometric data of the machine determined on a basis of n measurements performed by the measuring device on workpieces previously processed by the machine, wherein n <m;
correlation of the statistical long-term evaluation with the statistical short-term evaluation and determination of a geometric change in at least one axis of the machine.

24. An apparatus according to claim 23, wherein the analytic module is to determine whether a geometric change in at least one axis of the machine has occurred based at least in part on at least one predefined condition and/or rule.

25. An apparatus according to claim 23, wherein the analytic module is to initiate one or more of the following actions when it is determined that a geometric change occurred:
output of an acoustic warning,
output of a visual warning,
posting of a message,
dispatch of an email message.

26. An apparatus according to claim 25, wherein the visual warning includes a notification on a display.
